(19) United States
(12) Patent Application Publication
(10) Pub. No.: US 2022/0398258 A1
(43) Pub. Date: Dec. 15, 2022

(54) VIRTUAL PRIVATE DATA LAKES AND DATA CORRELATION DISCOVERY TOOL FOR IMPORTED DATA

(71) Applicant: SAP SE, Waldorf (DE)

(72) Inventors: Peter Eberlein, Malsch (DE); Volker Driesen, Heidelberg (DE)

(21) Appl. No.: 17/342,843

(22) Filed: Jun. 9, 2021

(51) Int. Cl. G06F 16/28; G06F 21/62; G06N 20/00; G06F 16/25

(52) U.S. Cl. CPC G06F 16/283; G06F 16/287; G06F 21/6218; G06N 20/00; G06F 16/256

(57) ABSTRACT

Methods, systems, and computer-readable storage media for providing a VPDL within a data exploration system, storing enterprise-provided data in the VPDL, the enterprise-provided data including enterprise data from an enterprise system and data lake data from an enterprise data lake, importing, from an external data source, external data, automatically identifying associations between a sub-set of the enterprise-provided data and a sub-set of the external data and storing correlation data in the VPDL in response to an association, and reading at least a portion of the enterprise-provided data, at least a portion of the external data, and at least a portion of the correlation data, the data exploration tool being configured to generate one or more of visualizations and analytics by processing the at least a portion of the enterprise-provided data, the at least a portion of the external data, and the at least a portion of the correlation data.

### BACKGROUND

Software systems can be provisioned by software vendors to enable enterprises to conduct operations. Software systems can include various applications that provide functionality for execution of enterprise operations. Over the course of the execution of operations, data (often significant amounts of data) is generated and stored. The data can be subsequently analyzed and/or explored by users to plan and execute enterprise operations. Typical environments accessed by users provide data analysis on pre-defined data domains available in the software systems or in a data lake of the enterprise. For example, data can be stored within a data lake as-is without having to structure the data. In some examples, a data lake enables different types of analytics to be executed over the data including, for example, dashboards, visualizations, big data processing, real-time analytics, and machine learning (ML).

The use cases for data analysis are largely pre-defined by the enterprise, because, providing the use cases typically requires development, maintenance, and operation efforts, which results in long-term costs. Some analytics products (e.g., SAP Analytics Cloud provided by SAP SE of Walldorf, Germany) seek to overcome the static modeling prerequisites to enable more flexible and dynamic analysis. However, such tools are generally restricted to analytics (e.g., slicing and dicing data to derive aggregated results).

In many instances, however, users may wish to explore data further and go beyond analytics queries and beyond individual data sets. If a user wants to have an enterprise data lake (EDL) onboard data not already present, a use case would have to be prepared, costs and return on investment (ROI) planned, for example, and then the data onboarding needs to be planned by the technical team that manages the enterprise data lake. More particularly, enterprise data lakes are operated by dedicated technical teams, and adding data is not a self-service activity for users, who are not members of the data lake technical team. Because the enterprise data lake is shared among multiple users, there is a governance process in place that prevents uncontrolled growth and low-quality data that is not maintained appropriately. Even if new data is onboarded to an enterprise data lake, links between existing and newly added data elements need to be created manually by trained and experienced data analysts to enable correlation between the various data sets. The process can thus be time consuming, resource intensive, and cumbersome, and it may come with additional hurdles.

Because additional data cannot be readily onboarded to an enterprise data lake, enterprise data lakes do not support user-specific ad-hoc analytics. Instead, a user takes the opposite approach and extracts data from their own enterprise systems or enterprise data lake to a local computing device (e.g., desktop computer, laptop computer or utilizing cloud resources) and combines the extracted data with data from other sources. The user then explores the combined data with the restricted capabilities of a desktop tool (e.g., Excel, notebooks) and without the advanced features that enterprise-level tools would provide (e.g., data correlation).

That is, for example, correlating data across distributed data sets is difficult and can be particularly difficult for inexperienced users. Typically, different data domains can be correlated using a set of fields that form an association. Whereas these associations are modeled in the enterprise system and are typically also available by replication in the enterprise data lake, identifying fields useful for correlating multiple data domains without such metadata is cumbersome, especially for larger data sets. Advanced data analysts would typically read data model definitions and manually check as to whether the values in the fields have a common subset or even overlap completely. Such tasks are already outside of the capabilities of inexperienced users, much less using desktop tools that have significantly limited capabilities as compared to enterprise-level tools with advanced features, such as data correlation.

### SUMMARY

Implementations of the present disclosure are directed to a data exploration system that enables user-specific ad-hoc data analysis on data combined from multiple, disparate data sources. More particularly, implementations of the present disclosure are directed to a data exploration system that enables provision of virtual private data lakes (VPDLs) for ad-hoc data analytics. As described in further detail herein, a VPDL enables enterprise data (replicated from enterprise systems and/or enterprise data lakes) to be combined and correlated with external data, the data onboarded to the VPDL being defined by a user.

In some implementations, actions include providing a VPDL within a data exploration system, storing enterprise-provided data in the VPDL, the enterprise-provided data including enterprise data from at least one enterprise system and data lake data from an enterprise data lake, importing, from at least one external data source, external data into the data exploration system, automatically identifying associations between at least a sub-set of the enterprise-provided data and at least a sub-set of the external data and storing correlation data in the VPDL in response to at least one association, and reading, by a data exploration tool, at least a portion of the enterprise-provided data, at least a portion of the external data, and at least a portion of the correlation data, the data exploration tool being configured to generate one or more of visualizations and analytics by processing the at least a portion of the enterprise-provided data, the at least a portion of the external data, and the at least a portion of the correlation data. Other implementations of this aspect include corresponding systems, apparatus, and computer programs, configured to perform the actions of the methods, encoded on computer storage devices.

These and other implementations can each optionally include one or more of the following features: providing a VPDL within a data exploration system at least partially includes defining a namespace within the enterprise data lake, the namespace being specific to a user, for which the VPDL is provided; storing enterprise-provided data in the VPDL at least partially includes replicating enterprise data to the VPDL and projecting data lake data to the VPDL; storing enterprise-provided data in the VPDL further includes storing replicated metadata and projection metadata in the VPDL, at least a portion of the replicated metadata and the projected metadata representing correlations between enterprise-provided data; automatically identifying associations between at least a sub-set of the enterprise-provided data and at least a sub-set of the external data includes transmitting a request to a machine learning (ML) system and receiving a response from the ML system, the response including the associations; the request includes data descriptions and data content of at least a portion of the external data and at least a portion of the enterprise-provided data, the data descriptions and the data content being processed by the ML system to identify the associations; and actions further include converting the external data from a first format to a second format for storage within the VPDL.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a block diagram of a data exploration system in accordance with implementations of the present disclosure.

FIG. 3 depicts an example flow diagram in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to a data exploration system that enables user-specific ad-hoc data analysis on data combined from multiple, disparate data sources. More particularly, implementations of the present disclosure are directed to a data exploration system that enables provision of virtual private data lakes (VPDLs) for ad-hoc data analytics. As described in further detail herein, a VPDL enables enterprise data (replicated from enterprise systems and/or enterprise data lakes) to be combined and correlated with external data, the data onboarded to the VPDL being defined by a user. Consequently, the VPDL is user-specific. Implementations can include actions of providing a VPDL within a data exploration system, storing enterprise-provided data in the VPDL, the enterprise-provided data including enterprise data from at least one enterprise system and data lake data from an enterprise data lake, importing, from at least one external data source, external data into the data exploration system, automatically identifying associations between at least a sub-set of the enterprise-provided data and at least a sub-set of the external data and storing correlation data in the VPDL in response to at least one association, and reading, by a data exploration tool, at least a portion of the enterprise-provided data, at least a portion of the external data, and at least a portion of the correlation data, the data exploration tool being configured to generate one or more of visualizations and analytics by processing the at least a portion of the enterprise-provided data, the at least a portion of the external data, and the at least a portion of the correlation data.

As described in further detail herein, the data exploration system of the present disclosure enables ad-hoc data exploration for citizen developers and/or casual users on a personally assembled set of data domains of various data sources. Users may want to explore publicly available data or data received from a third-party source, correlated with virtualized data (replicated) of their own enterprise available in a consolidated enterprise data lake (EDL) and/or data from backend enterprise systems. The data exploration system provides for user-driven assembly of a VPDL, which can be ad-hoc extended with snapshot data (replicated data from enterprise system(s) and/or EDL) that is valid for a limited lifespan. The data exploration system of the present disclosure enriches the data combined in the VPDL with auto-generated data correlation. For example, and as described herein, a machine learning (ML) system can process data to determine correlations therebetween and can provide associations representative of the correlations to the VPDL. The data exploration system enables low-code/no-code data exploration at a faster pace and at lower administrative, personnel, and technical costs. This supports new data-driven enterprise scenarios for individual use and as a proof of concept (PoC) before enterprise-wide adoption.

As used herein, the term citizen developer generally refers to users who have little or no development experience yet seek to perform activities requiring some level of development experience. In the context of the present disclosure, an example activity can include establishing and populating a data lake. As used herein, the term casual user generally refers to a user that has little to no experience, education, and/or expertise in a particular subject matter that the user is to interact with and/or tasks that are to be performed. For example, a casual user may need to interact with a particular process that is executed as part of the operations of an enterprise and yet have little to no experience with the particular process. In some examples, a casual user may also be a citizen developer.

To provide further context for implementations of the present disclosure, and as introduced above, software systems can be provisioned by software vendors to enable enterprises to conduct operations. Software systems can include various applications that provide functionality for execution of enterprise operations. Over the course of execution of operations data, often significant amounts of data, is generated and stored. The data can be subsequently analyzed and/or explored by users to plan and execute enterprise operations. Typical environments accessed by users provide data analysis on pre-defined data domains available in the software systems or in a data lake of the enterprise. In some examples, a data lake can be described as a central repository to store structured and unstructured data at any scale. For example, data can be stored within a data lake as-is without having to structure the data. In some examples, a data lake enables different types of analytics to be executed over the data including, for example, dashboards, visualizations, big data processing, real-time analytics, and machine learning (ML).

The use cases for data analysis are largely pre-defined by the enterprise because providing the use cases typically requires development, maintenance, and operation efforts, which result in long-term costs. Some analytics products (e.g., SAP Analytics Cloud provided by SAP SE of Walldorf, Germany) are pushing to overcome the static modeling pre-requisites and enable more flexible and dynamic analysis. However, such analytics tools are restricted to the analytics space (e.g., slicing and dicing data to derive aggregated results).

In many instances, however, users may have a new idea about which data they would like to further explore for a particular scenario and may wish to go beyond analytics queries and evaluating individual data sets broken down by record. For example, a casual user within an enterprise can plan a marketing campaign to leverage data that is external to the enterprise systems (e.g., governmental data, data on credit standing offered by financial data brokers, data by trade associations). If a user wanted to have a data lake of the enterprise onboard data, the use case would have to be prepared, costs and return-on-investment (ROI) planned, for example, and then the data onboarding needs to be planned by the technical team that manages the data lake. Links between existing and newly added data elements need to be created manually by trained and experienced data analysts to enable correlation between the various data sets. The process can thus be time and resource consuming, cumbersome and come with additional hurdles. Consequently, casual users that may have an idea they want to act on likely back off from this endeavor. On the other hand, correlating new data domains, which are not used in existing enterprise processes can provide a competitive advantage, and be the starting point for an extended scenario in the future, once it has been evaluated and was proven to deliver tangible benefits.

In many cases, distributed data is difficult to analyze for casual users. For example, when users need to combine data from different sources, the users typically download the data to their local computer, import the date in a spreadsheet (e.g., Excel) or similar desktop tools, and explore the data with the functionality available in these tools. Casual users, however, are typically unaware of how data between disparate data sources might correlate to one another or even data within a single data source. The vastly more powerful enterprise tools, however, operate only on data stored in enterprise systems or in an EDL. If additional external data is required, the data cannot easily be brought into the enterprise systems or EDL by the user themself, so the user has to take the opposite direction and also extract data from their own enterprise systems or EDL. The user then explores the combined data with the restricted capabilities of some desktop tool (e.g., Excel) missing out on the advanced features that their enterprise-level tools would provide (e.g., data correlation).

In many cases, correlating distributed data sets is difficult and can be particularly difficult for casual users. Typically, different data domains can be correlated using a set of fields that form an association. Whereas these associations are modeled in the enterprise system and are typically also available by replication in the EDL, identifying fields useful for correlating multiple data domains without such metadata is cumbersome, especially for larger data sets. Advanced data analysts would typically read data model definitions and manually check as to whether the values in the fields have a common subset or even overlap completely. Such tasks are already outside of the capabilities of casual users.

Further, EDLs are operated by dedicated technical teams and adding data is not a self-service activity for citizen developers, who are not a member of the EDL technical team. If a user has identified an interesting dataset—either from internal enterprise systems not yet connected to the EDL or from external sources—and thinks this should be correlated with existing data in the EDL, the process of onboarding the data is restricted to members of the technical team. Because the EDL is shared among multiple users, there is a governance process in place that prevents uncontrolled growth and low-quality data that is not maintained appropriately. It is not possible to create unmanaged private sections that would enable the EDL to be used for user-specific ad-hoc analysis.

Also, citizen developers typically do not have a PoC environment for data driven processes. For example, when employees of an enterprise have an idea for a new enterprise process, it is typically hard to convince management to spend development capacity and money on the idea unless they can show a PoC and have verified the proposal(s). For ideas around data driven processes, it may be required to combine data domains not yet combined before. Such environments are typically only accessible for actual developers in the IT department and not for casual users acting as citizen developers.

In view of the above context, implementations of the present disclosure provide a data exploration system that provides VPDLs upon request by casual users (who can also be citizen developers). In accordance with the present disclosure, each VPDL contains configurable data content, the ability to upload external data, has support for auto-generating data correlations, and can interact with advanced data science tools and ML functions. As described in further detail herein, the VPDL can be a user individual persistency, which can be populated with multiple, disparate data. That is, for example, a VPDL can be provided as a namespace within an existing EDL, the VPDL being accessible by a specific user (or users), who are provided credentials to access the namespace (e.g., by the technical team of the EDL). Example data can include, without limitation, data extracted from enterprise systems that are not yet part of an EDL (the data is amended with metadata on structure and associations to other data domains), data overlayed from an EDL, data uploaded by the user (e.g., public data, third-party data), data provided by third-party enterprises to be read through application programming interfaces (APIs) (e.g., offerings by hyperscalers on curated open data sets), and user individual data and data annotations and labeling information for ML.

In accordance with implementations of the present disclosure, and as described in further detail herein, the data exploration system has tools to correlate data sets of the different origins (e.g., based on metadata provided by the enterprise system and/or EDL, based on metadata provided by the open data (if available), based on ML computing correlation efficiency of data fields, based on user annotations and/or tagging). The user can explore the data using, for example, tabular visualizations and/or graphical visualizations, and/or can process data using ML to evaluate the desired prediction, clustering, correlation, and the like.

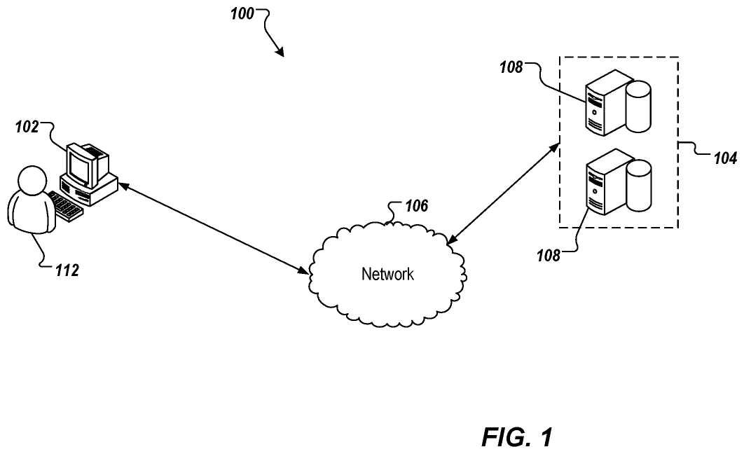

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., public switched telephone network (PSTN)) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host at least a portion of a data exploration system. For example, the user 112 can access the data exploration system using the client device 102 to instantiate a VPDL. As described in further detail herein, the user 112 interacts with the data exploration system to define data that is to be stored in the VPDL. In some examples, the user 112 can request that a VPDL be created. In response, the technical team managing an EDL can create a VPDL within the EDL using a namespace that is specific to the user 112 and can grant the user 112 credentials to access and interact with the VPDL.

In some examples, the user 112 can interact with a data analytics tool (e.g., hosted by the server system 104) to identify data from one or more enterprise systems and/or from an EDL that is to be stored in the VPDL. The identified data is replicated and/or projected to the VPDL for storage. Further, metadata that represents the structure of the data in the original enterprise data source (e.g., enterprise system, EDL) is stored in the VPDL. Accordingly, the data replicated and/or projected to the VPDL is disconnected from the original enterprise data source (e.g., enterprise system, EDL). That is, the data is not updated or modified as enterprise operations continue to execute. In this manner, at least a portion of the data (e.g., data that is dynamic in view of on-going enterprise operations) has a limited lifespan of relevancy and/or accuracy (validity). That is, data within the VPDL can become stale over time.

In some examples, projected data refers to data that can be read from a remote data source (e.g., a database) that is selectively exposed by the remote source. For example, limited to one or more tables and certain fields of each table. In other terms, a projection view selects only particular fields of a table and values stored therein. In some examples, a projection view can modify the data to provide the modified data as the projected data. Example modifications can include, without limitation, transforming field values, aggregation, and exposing only a subset of keys (e.g., using SQL views, SAP calculation views, etc.).

Data from one or more external data sources can be imported into the VPDL. For example, the user 112 can identify one or more external data sources (and data of each) that is to be imported into the VPDL and the data exploration system imports the data. As described in further detail herein, correlations between data of the enterprise (e.g., from the enterprise system(s) and/or the EDL) can be automatically determined by the data exploration system. For example, the combined data can be provided to a ML system that processes the combined data to determined correlations between data. In some examples, correlations can be indicated from associations that are provided, an association indicating a likelihood that data could be correlated. In some examples, the correlation can include a foreign key relationship between the data. The correlation data is stored in the VPDL.

With the data populated to the VPDL and correlations provided between data, the user 112 can execute data exploration using the data analytics tool (e.g., SAP Analytics Cloud). For example, and as described in further detail herein, the data analytics tool reads data from the VPDL through an API to provide analytics artifacts (e.g., graphical visualizations, tabular visualizations, statistics), which can be referred to as exploration results. In some examples, the user 112 can use the data exploration system to export the exploration result to an enterprise system. In some examples, after the user 112 completes their work, the VPDL is dismantled (e.g., the data and metadata within the VPDL is erased). That is, for example, the technical team that manages the EDL can delete the namespace and any data stored therein.

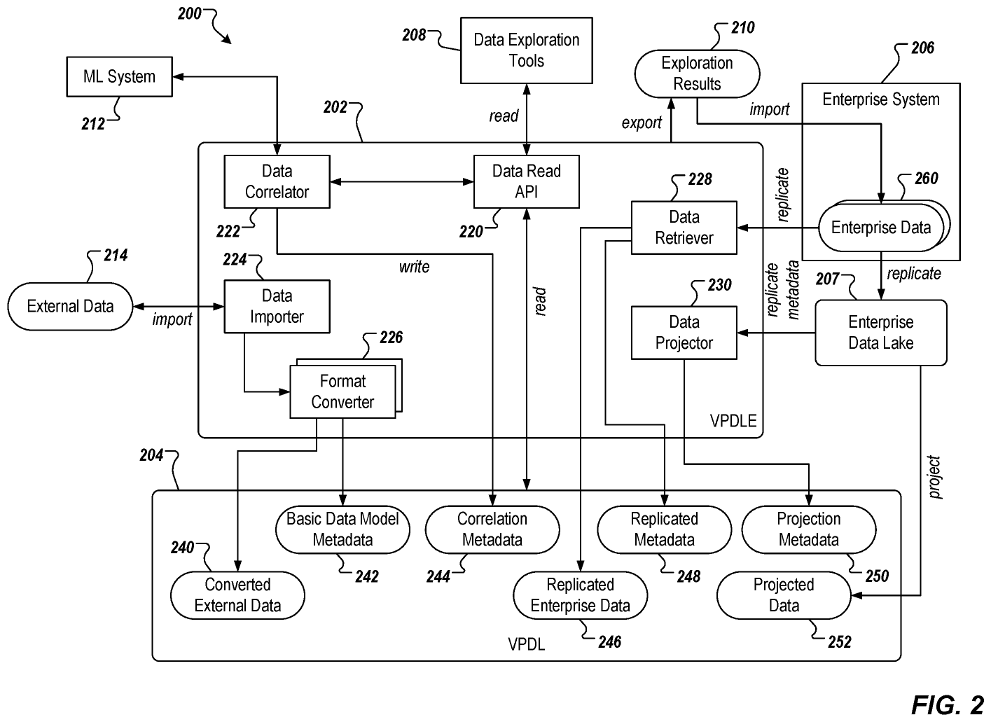

FIG. 2 depicts a block diagram of a data exploration system 200 in accordance with implementations of the present disclosure. In the depicted example, the data exploration system 200 includes a VPDL engine (VPDLE) 202, a VPDL 204, an enterprise system 206, an EDL 207, and one or more data exploration tools 208. In some examples, and although a single enterprise system 206 is depicted in FIG. 2, the data exploration system of the present disclosure can interact with multiple enterprise systems 206. Example enterprise systems include, without limitation, enterprise resource planning (ERP) systems, customer relationship management (CRM) systems, and human capital management (HCM) systems. In some examples, and although depicted separately in FIG. 2, the VPDL 204 can be provided as a namespace within the EDL 207. The data exploration system 200 also includes exploration results 210, a ML system 212, and external data 214. In the depicted example, the VPDLE 202 includes a data read API 220, a data correlator 222, a data importer 224, one or more format converters 226, a data retriever 228, and a data projector 230. The VPDL 204 stores converted external data 240, basic data model metadata 242, correlation metadata 244, replicated enterprise data 246, replicated metadata 248, projection metadata 250, and projected data 252.

In some examples, the one or more data exploration tools 208 can be provided as enterprise-level data exploration and/or analytics tools. An example tool includes, without limitation, SAP Analytics Cloud. Accordingly, the exploration tools 208 can be the same tools that users use to conduct exploration and analytics over data stored in the enterprise system 206 and/or the EDL 207 of the enterprise. In this manner, users are provided with comprehensive functionality in terms of analytics and exploration on data provided from the VPDL 204.

In some examples, the data read API 220 enables access to the data assembled in the VPDL 204. More particularly, for users, the data persisted in the VPDL 204 is exposed through the data read API 220, which is compatible to an API used to access the EDL 262. This enables using all existing enterprise data exploration tools 208 operating on the EDL 262 to also work with the VPDL 204. The data read API 220 provides access to data imported to the VPDL 220 and can also be used to retrieve projected data from the EDL 262 through remote source (e.g., SAP HANA Smart Data Access, Ingest Pipelines).

In some examples, the data correlator 222 reads the metadata stored in the VPDL 222 by the each of the data projector 230, the data retriever 228, and the data importer 224. The data correlator 222 uses foreign key relations of existing data models to find associations between data domains in the VPDL 204. In some examples, known domains can be provided and can be represented in an enterprise domain model and/or an enterprise knowledge graph, which can be used to compute foreign key relations. In some examples, the data correlator 222 leverages the ML system 212 to compute which fields correlate to one another based on, for example, data headers and content. For example, the data correlator 222 can send a request to the ML system 212, the request including data headers and content, for example, of disparate data and the ML system 212 provides (e.g., by processing the data through one or more ML models that are trained to determine correlations) a response including associations and/or correlations between the disparate data. In some examples, the values of fields of third-party data and/or of enterprise data can be evaluated to identify highly correlated data fields. The data correlator writes the returned correlations as the correlation metadata 244 in the VPDL 204.

In some examples, the data importer 224 is used to upload (import) external data 214 (e.g., from one or more third-party data sources) to the VPDL 224. For example, external data 214 can be provided from one or more public data sources (e.g., government data sources), which can be imported into the VPDL 204. In some instances, the data format of the external data 214 can vary from source-to-source. In view of this, a format converter 226 can be selected based on the particular data format of the external data 214 to read the external data 214 and transform the external data 214 to an appropriate format for storage in and consumption from the VPDL 204. The external data 214 is stored as the converted external data 240 together with the basic data model metadata 242.

In some examples, external data can be provided as a CSV file, a JSON file, a XML, and/or Excel file, among other example file types. The data format is transformed from any of these file types to what the VPDL 204 uses to store data (e.g., parquet files, database tables, etc.). Modules are available to transform these data formats to “parquet” or “tables” or the appropriate format for the VPDL 204. In some examples, the VPDL 204 supports a subset of file-types/tables/graphs that the VPDL 204 can efficiently process. In view of this, the import of external data includes a transformation to a format supported by the VPDL 204. In some instances, external data sources provide a data model together with the external data, the data model defining, for example, data types (field type like “string,” “float,” “int,” “mpeg,” etc.), data field names (e.g., “address,” “problem description,” “amount,” “currency,” etc.), data structure names (e.g., “geo location,” “geo regions,” “invoice,” “sales order,” etc.), and structure formats (e.g. defined as extensible stylesheet language (XSL), table, or view definitions).

In some examples, the data retriever 228 imports at least a portion of the enterprise data 260 from the enterprise system 206. In some examples, the import can be performed using a user interface (UI) of the enterprise system 206, through which the user specifies the enterprise data 260 to view. The (viewed) enterprise data 260 is exported from the enterprise system 206 along with underlying model metadata to the VPDL as a snapshot (i.e., as the replicated enterprise data 246 and the replicated metadata 248, respectively). In some examples, the download of the selected enterprise data 260 into the VPDL 204 is performed through an API of the enterprise system 206, which can write to the EDL 207, but here writes to the VPDL 204. The data retriever stores the retrieved data in the VPDL 204 as the replicated enterprise data 246 together with the data model metadata and associations to other data domains specified in the enterprise system 206 as the replicated metadata 248.

In some examples, the data projector 230 is accessed by the user to specify which data domain to read from and for which selection criteria and time frame. The user can specify this information based on information provided in an EDL catalog. The data projector 230 replicates the data model (metadata) of the desired content from the EDL 207 (as defined in the EDL catalog), which can be filtered by the data fields the user selected for projection. The data correlation to other domains in the EDL 207 is also defined in the EDL catalog and replicated to the VPDL 204 for subsequent use by the data correlator 222. The data projected from the EDL is stored as the projected data 252 along with the corresponding metadata as the projection metadata 250. The projected data 252 is accessible to be read through the data read API 220. The data projector 230 stores which data to be read from the EDL 207 (e.g., domain, selection criteria) in the VPDL 204, including the access information to the data in the EDL 207 (i.e., as the projection metadata 250).

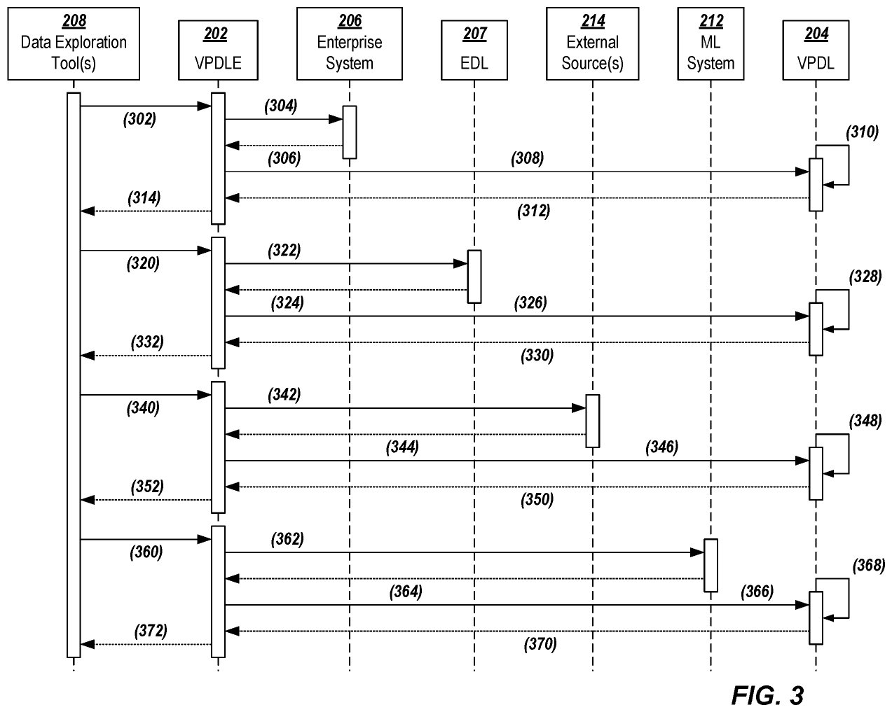

FIG. 3 depicts an example flow diagram 300 in accordance with implementations of the present disclosure. In some examples, a user (e.g., the user 112 of FIG. 1) wants to create a VPDL. For this, a namespace (private namespace) is created for the user in the EDL 207. For example, an EDL team member can create the namespace for the user in the EDL 207 and can grant the user write access to the namespace.

The user interacts (302) with the VPDLE 202 through the data exploration tool(s) 208 to define enterprise data of one or more enterprise systems 206 to be made available within the VPDL. For example, an enterprise system 206 is called (304) to list enterprise data that is relevant for a user-specified use case and exports (306) the enterprise data to the VPDLE 202, which stores (308, 310) the enterprise data in the VPDL 204. Confirmations are sent (312, 314) to confirm that the enterprise data is resident in the VPDL 204. For example, the user calls a data display UI in the enterprise system 206 for the data domain of interest, specifies the selection criteria for display of relevant enterprise data (e.g., and can optimize, such as filtering, to drill down to the relevant enterprise data). The user can initiate, through the UI of the enterprise system 206, export of the enterprise data to a file (e.g., for subsequent uploading) or directly to the VPDLE/VPDL. In some examples, the export enriches the enterprise data with data model metadata as well as associations to other data domains available in the enterprise system. The VPDL 204 stores the replicated metadata 248 and the replicated enterprise data 246, as discussed above.

The user interacts (320) with the VPDLE 202 through the data exploration tool(s) 208 to identify data of the EDL 207 that is to be available in the VPDL 204. In some examples, the user accesses the catalog of the EDL 207 and specifies (322), from the data identified in the catalog, which data is to be available in the VPDL. In some examples, specifying the data includes identifying data domain, data fields, and data filtering on certain fields (e.g., to narrow the data down to the dataset interesting to the problem to be solved). In some examples, the EDL 207 checks for read authorization of the user on the specified dataset. If the user is not authorized to read some or part of the data in the dataset, the user can request additional read access using one or more access control processes implemented by the enterprise. The EDL 207 provides (324) the dataset (which includes only data that the user has read access for) to the VPDLE 202, which stores (326, 328) the enterprise data in the VPDL 204. Confirmations are sent (330, 332) to confirm that the enterprise data is resident in the VPDL 204. In some examples, the VPDL 204 stores the metadata entered by the user as the projection metadata 250 of FIG. 2, which describes the data domains (e.g., tables) and records (e.g., selection criteria) that are to be visible from the VPDL 204. The projection metadata 250 can be used to generate read access within the VPDL 204 to the projected data 252 (e.g., a view, read-API, ingest-pipeline, etc.).

Because the EDL 207 is already built as a replication of parts of the enterprise data of the enterprise system 206, the EDL 207 contains model data of the already replicated enterprise data (i.e., the enterprise data that had already been replicated to the EDL 207). In view of this, and in some examples, the VPDLE 202 can also trigger the data replication from the enterprise system 206 to the VPDL 204 through an API of the enterprise system 206 using the specified metadata and user credentials. In this manner, additional data can be replicated from the enterprise system 206 that is not yet available in the EDL 207. In some examples, metadata already stored in the EDL 207 and new metadata from the enterprise system 206 can be used to correlate data elements and create corresponding associations that can later be used for navigation through the EDL 207.

In some examples, privacy regulations (e.g., General Data Protection Regulation (GDPR)) and privacy checks can be processed. For example, if anything can be added to the VPDL 204 and the data is stored in a new persistency and is used for new, additional enterprisegoals, not previously specified, privacy checks can be required to ensure data privacy and compliance with privacy regulations. In view of this, the extraction of domains from the enterprise system 206 can be extended by checking metadata at the data specified to replicate by the user. If it is defined as person-related data, for example, the particular data can be excluded from the data export from the enterprise system 206 or is anonymized as part of the export process (e.g., processed by a data anonymizer, which removes any personally identifiable information (PII)). In some examples, the privacy check process can be extended with additional checks for data in cases where metadata about person-related data is missing. For example, a rule-based system and/or a ML model trained to identify person-related data can be called to process the data. If a data field is identified to be potentially person-related, the field is shown to the user with options on how to proceed. In some examples, the user can select to include the data in the export, exclude the data from the export, or anonymize the data in the field before exporting.

The user interacts (340) with the VPDLE 202 through the data exploration tool(s) 208 to identify data of one or more external data sources 214 that is to be uploaded to the VPDL 204. For example, the user can provide information (e.g., uniform resource locator (URL)) for data that is to be imported from third-party sources as a file that is to be downloaded. For example, the file can be provided in any appropriate format (e.g., comma-separated values (CSV), Javascript object notation (JSON), or other structured file formats). The external data is requested (342) from the external source(s) 214 and is returned to the VPDL 202, which stores (346, 348) the external data in the VPDL 204. Confirmations are sent (350, 352) to confirm that the external data is resident in the VPDL 204. The external data is stored as the converted external data 240 in the VPDL 204.

In further detail, and as discussed above, a data importer 224 of the VPDLE 202 can be provided and support many pre-defined formats with a set of format converters 226. In some examples, as a file is imported, an appropriate format converter 226 is selected based on the file type (e.g., CSV, JSON) and processes the file to a format that is accessible by the data read API 220 (e.g., JSON). In some examples, the data importer 224 also stores potentially available metadata (e.g., on field names, structures, associations, etc.) as the basic data model metadata 242.

In some examples, external data can be read into the VPDLE 202 using an API from a specified URL for direct import into the VPDL 204. That is, some external data can be offered for download through an API. In such cases, download of the data can be performed based on any appropriate protocol, such as the open data (OData) protocol.

In accordance with implementations of the present disclosure, and as introduced above, correlation of data domains is computed. More particularly, the external data is correlated with the enterprise-provided data in the VPDL 204. For the enterprise-provided data (i.e., enterprise data from the enterprise system 206, data from the EDL 207) on the other hand, domains, data models, association models, and the like are provided. For example, for enterprise data of the enterprise system 206, the vendor that provides the enterprise system 206 provides domain models. As another example, the enterprise operating the enterprise system 206 and the EDL 207 might maintain its own enterprise knowledge graph, which defines entities and relationships between entities, as relevant to the particular enterprise. A similar concept includes maintaining a so-called business graph. In some examples, a business graph can be described as a representation of business data in a graph format (e.g., a graph database (DB)). Each data object (referred to as a business object (BO)) as defined in the business application holding information (e.g., a sales order) is represented as a node in the business graph, each association between two BOs as an edge in the business graph. The business graph enables relating BO representations to other BO representations, like relating two BOs stored in a relational DB with a join, but independent of where and how the BOs are actually stored. Such information can be used to, for example, retrieve foreign key relations to correlate data provided from the enterprise system 206 and data provided from the EDL 207. In some examples, data from different enterprise systems (e.g., ERP, CRM systems) can be stored in the EDL 207. The data from the different enterprise systems can be correlated through foreign key relationships. For example, an advertisement campaign in CRM having the address of the customers, these addresses can be found in the ERP system on sales orders. Either these foreign key relationships can be modeled within a single database of one system, or they are captured in a business graph that goes across systems. In both cases, the relationship information can be replicated to the EDL 207.

However, with some external data either no metadata or only basic metadata for computing correlations is provided. That is, while some external data has a basic data model associated therewith, there are no defined associations between the external data and the enterprise-provided data. In view of this, implementations of the present disclosure leverage the ML system 212 to derive associations between external data and enterprise-provided data. In some examples, the ML system 212 identifies potential correlations using content analysis. To achieve this, the VPDLE 202 feeds data description and content to the ML system 212, which provides the correlation metadata 244 identifying correlated data, if any. In some examples, before being included in the correlation metadata 244, automatically identified correlations can be presented to the user to confirm whether the correlations are to be included.

In some examples, content analysis includes matching content between the external data and the enterprise-provided data using one or more ML models. If a ML model indicates that data of the external data and data from the enterprise-provided data are the same or sufficiently similar an association can be provided between the data. In some examples, an association (e.g., a data value (flag)) is an indication that the external data and data from the enterprise-provided data could be correlated. For example, if the data of a field in the external data and a field in the enterprise-provided data have a threshold set of common values, the fields are identified as being associated, and hence, an association can be provided indicating that the data could be correlated. In some examples, data descriptions (e.g., zip code, e-mail) are read (by the ML system 212), which data descriptions already provide some hint about fields that may be correlated. In some examples, data content is read (by the ML system 212) to prove or invalidate fields for correlation. For example, data sets with disjunct data make no sense to be correlated. On the other hand, if a reasonable number of records contain data that matches other dataset records, an association is automatically generated.

In some examples, if an association is determined for data, a correlation can automatically be provided. In some examples, the correlation can include a foreign key relationship between the data. For example, the data correlator 222 can receive an association for a data set (i.e., data of the external data and data from the enterprise-provided data) from the ML system 212 and a confidence score associated with the association. The confidence score represents a degree of confidence that the ML system 212 has in the association it had determined for the data set. If the confidence score exceeds a threshold confidence score, a correlation is generated to provide a hard correlation between the data in the data set. In some examples, if an association is determined for data, a correlation can be suggested to the user. If the user indicates approval, the correlation is generated.

Referring again to FIG. 3, after the enterprise-provided data and the external data have been added to the VPDL 204, the user can indicate (360) that the data assembly is complete. In response, the VPDLE 202 assembles and sends (362) a request to the ML system 212 to provide correlation data. In some examples, the request includes data descriptions and data content of at least a portion of the external data and at least a portion of the enterprise-provided data. The ML system 212 processes the request and sends (364) a response to the VPDLE 202, the response including correlation data representing associations identified by the ML system 212. In some examples, the VPDLE 202 provides the correlation data to the user for approval and/or editing. If the correlation data is to be stored, the VPDLE 202 stores (366, 368) the correlation data in the VPDL 204. Confirmations are sent (370, 372) to confirm that the correlation data is resident in the VPDL 204. The correlation data is stored as the correlation data 244 in the VPDL 204.

At the end of the example flow 300 of FIG. 3, all data and correlations are available in the VPDL. From here, the user can use the data exploration tool(s) 208 available for exploration on the EDL 207 as well as on the VPDL 204. In some examples, the user can generate data visualizations for the combined dataset. In some examples, the data of the VPDL 204 can be leveraged for training improvement in a ML scenario. For example, the user can run ML and/or add annotations and labels to the data as input to supervised ML. Example applications can include computing predictions, correlations, and/or clusters. In some examples, analytics tools can execute on the data in the VPDL 204.

Results of data exploration and/or analytics (e.g., the exploration results 210) can be exported back into the enterprise system 206 and/or can be provided as input for execution of enterprise processes (e.g., run a marketing campaign for business partners identified in the exploration). Once the user is done with data exploration, the VPDL 204 can be deleted (e.g., drop projections, delete imported data).

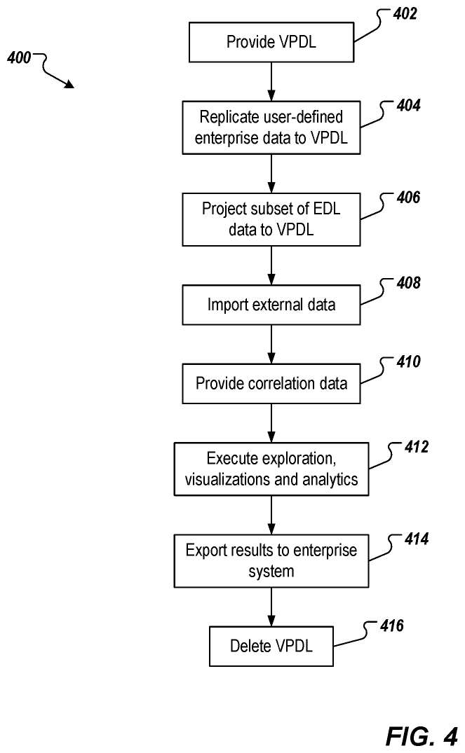

FIG. 4 depicts an example process 400 that can be executed in accordance with implementations of the present disclosure. In some examples, the example process 400 is provided using one or more computer-executable programs executed by one or more computing devices.

A VPDL is provided (402). For example, and as described herein, a namespace (private namespace) is created for the user in the EDL 207 (e.g., an EDL team member can create the namespace for the user in the EDL 207 and can grant the user write access to the namespace). User-defined enterprise data is replicated to the VPDL (404). For example, and as described herein, the user interacts with the VPDLE 202 through the data exploration tool(s) 208 to define enterprise data of one or more enterprise systems 206 to be made available within the VPDL. For example, an enterprise system 206 is called to list enterprise data that is relevant for a user-specified use case and exports the enterprise data to the VPDLE 202, which stores the enterprise data in the VPDL 204.

A sub-set of EDL is projected to the VPDL (406). For example, and as described herein, the user interacts with the VPDLE 202 through the data exploration tool(s) 208 to identify data of the EDL 207 that is to be available in the VPDL 204. In some examples, the user accesses the catalog of the EDL 207 and specifies, from the data identified in the catalog, which data is to be available in the VPDL 204. The EDL 207 provides the dataset (which includes only data that the user has read access for) to the VPDLE 202, which stores the enterprise data in the VPDL 204.

External data is imported (408). For example, and as described herein, the user interacts with the VPDLE 202 through the data exploration tool(s) 208 to identify data of one or more external data sources 214 that is to be uploaded to the VPDL 204. For example, the user can provide information (e.g., uniform resource locator (URL)) for data that is to be imported from third-party sources as a file that is to be downloaded. The external data is requested from the external source(s) 214 and is returned to the VPDL 202, which stores the external data in the VPDL 204. Correlation data is provided (410). For example, and as described herein, the VPDLE 202 assembles and sends a request to the ML system 212 to provide correlation data and the ML system 212 processes the request and sends a response to the VPDLE 202, the response including correlation data representing associations identified by the ML system 212. The correlation data is stored as the correlation data 244 in the VPDL 204.

Exploration, visualization, and/or analytics are executed (412). For example, and as described herein, the user interacts with the VPDL 204 through the data exploration tools 208, to provide results. Results are exported to the enterprise system (414). The VPDL is deleted (416). For example, and as described herein, the technical team that manages the EDL can delete the namespace and any data stored therein.

Implementations of the present disclosure can be used to realize a number of use cases. Example use cases are discussed herein without limitation.

In a first example use case, a user (an employee of an enterprise) is to organize sales of goods that the company has too much stock in in a variety of locations across the world. This can include, for example, goods that are not easy to deliver and, therefore, must be sold locally. Thus, the task for the user can be described as: to run a marketing campaign, to address customers in the localities where the goods are on stock and where local shipment is possible and inexpensive. The enterprise has an enterprise system that is used to manage the stock of their products, where the available quantity per warehouse is maintained. Further, enterprise has an EDL with experience and sales analysis data that provides insights into which customer group purchased which products in the past.

The user has the idea to run a campaign on local radio stations and wants to identify which radio stations broadcast in the regions where stock is available and at the same time identify a typical audience that matches the customer group which buys the overstock products. The user finds publicly available data on radio stations and their broadcast region (e.g., for Germany, the website ‘Sender in Ihrer Nähe (radio.de)’). Additional data is available as to which radio station offers to run ads, their target audience, and how to book ads (e.g., for Germany, the website ‘Übersicht Radiosender—Alle Sender für Radiowerbung (crossvertise.com)’). The user uses the self-service of the VPDL of the present disclosure and creates their own space. The user selects, in the enterprise system, the inventory per product (e.g., using a system that covers the core elements of warehouse structure, master data, inventory management, handling unit management, warehouse task and warehouse order creation, inventory control and comprehensive control system functions). The user exports the enterprise data to the VPDL for the products to be advertised.

In this example, the enterprise-provided data includes a) region: stock available in a warehouse in the region, and b) user profile of earlier customers—identify a common customer profile (e.g., male, 20-30 years, Hispanic), and the external data includes c) list of radio stations, with target area regional broadcast/market share (in target area), and d) user profiles of audiences of other radio stations. Correlating a) and c) identifies the radio stations broadcasting in the regions of interest, and correlating b) and d) identifies the radio stations with the audience of interest. These are the stations the user wants to contact to place the ads for the overstock products.

In a second example use case, an enterprise sells goods and experiences sporadically bad payment behavior, although they are already checking their customers' creditworthiness with an external credit rating service to restrict payment options for lower-rated customers. A user (employee of the enterprise) has the idea to use the company's own dunning history data in addition to the generic credit ratings they receive from the external service provider in order to improve the quality of the credit ratings by making them more specific to the target customer group, which can be unique due to the company's unique product offering. Changing the enterprise system to evaluate the additional data is a complex task. In view of this, the new idea is to be evaluated before it is implemented enterprise-wide. The user thus wants to run the data analysis on “one-shot-data” for a set of customers to test whether the decisions about the offered payment options would improve.

In this example, a VPDL is created and customer data is replicated to the VPDL. The customer data can include dunning letters, for example. Enterprise partners or customers of the enterprise can be projected from an EDL to the VPDL. Accordingly, the enterprise-provided data represents customer payment behavior. In this example, an external data source can provide data that includes information on a person's credit rating, and payment behavior per region, zip code, city and street. Once the enterprise-provided data and the external data are stored in the VPDL, associations can be generated using the ML system based on zip code or city and street, for example.

The user can use the data exploration tools to run an analysis on dunning letters to determine whether the distribution matches the information provided by the external data source. Deviations between bad payment behavior experienced by the enterprise and the external data can be identified. The user can create the enterprise's own ratings for customers based on both input sources to restrict payment options for customers living in areas either rated badly by the external source or in areas of former customers that showed bad payment behavior. When the own rating algorithm with these two data sources shows improvements in payment, the company will likely want to establish the now validated business process modification enterprise-wide and onboard the external data together with dunning letters to the EDL and run the algorithm for all new order entries.

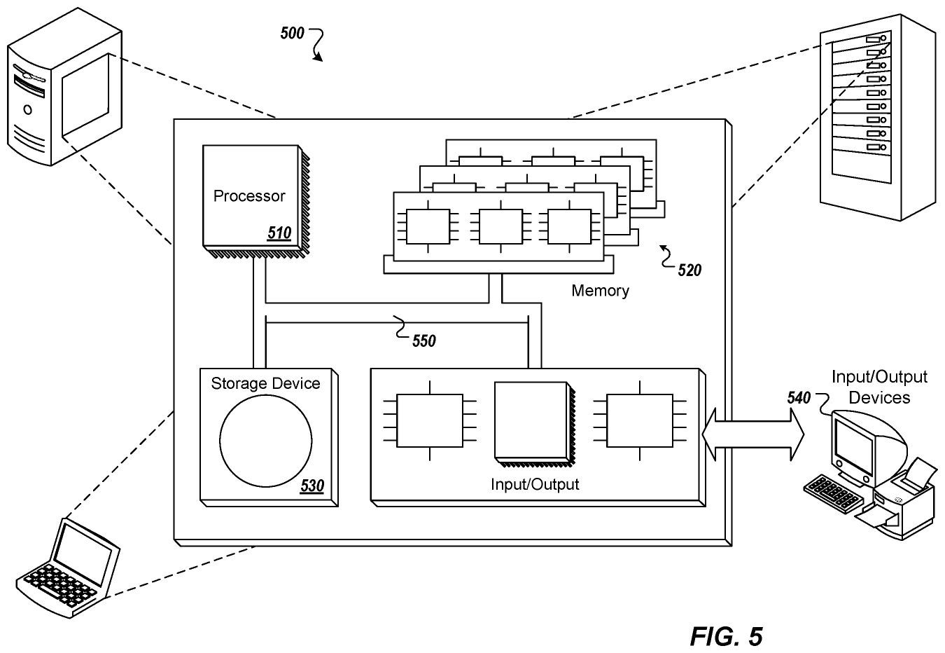

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a backend component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for provisioning virtual private data lakes (VPDLs) and correlating data from disparate data sources, the method being executed by one or more processors and comprising:
providing a VPDL within a data exploration system;
storing enterprise-provided data in the VPDL, the enterprise-provided data comprising enterprise data from at least one enterprise system and data lake data from an enterprise data lake;
importing, from at least one external data source, external data into the data exploration system;
automatically identifying associations between at least a sub-set of the enterprise-provided data and at least a sub-set of the external data and storing correlation data in the VPDL in response to at least one association; and
reading, by a data exploration tool, at least a portion of the enterprise-provided data, at least a portion of the external data, and at least a portion of the correlation data, the data exploration tool being configured to generate one or more of visualizations and analytics by processing the at least a portion of the enterprise-provided data, the at least a portion of the external data, and the at least a portion of the correlation data.

2. The method of claim 1, wherein providing a VPDL within a data exploration system at least partially comprises defining a namespace within the enterprise data lake, the namespace being specific to a user, for which the VPDL is provided.

3. The method of claim 1, wherein storing enterprise-provided data in the VPDL at least partially comprises replicating enterprise data to the VPDL and projecting data lake data to the VPDL.

4. The method of claim 1, wherein storing enterprise-provided data in the VPDL further comprises storing replicated metadata and projection metadata in the VPDL, at least a portion of the replicated metadata and the projected metadata representing correlations between enterprise-provided data.

5. The method of claim 1, wherein automatically identifying associations between at least a sub-set of the enterprise-provided data and at least a sub-set of the external data comprises transmitting a request to a machine learning (ML) system and receiving a response from the ML system, the response comprising the associations.

6. The method of claim 5, wherein the request comprises data descriptions and data content of at least a portion of the external data and at least a portion of the enterprise-provided data, the data descriptions and the data content being processed by the ML system to identify the associations.

7. The method of claim 1, further comprising converting the external data from a first format to a second format for storage within the VPDL.

8. A non-transitory computer-readable storage medium coupled to one or more processors and having instructions stored thereon which, when executed by the one or more processors, cause the one or more processors to perform operations for provisioning virtual private data lakes (VPDLs) and correlating data from disparate data sources, the operations comprising:
providing a VPDL within a data exploration system;
storing enterprise-provided data in the VPDL, the enterprise-provided data comprising enterprise data from at least one enterprise system and data lake data from an enterprise data lake;
importing, from at least one external data source, external data into the data exploration system;
automatically identifying associations between at least a sub-set of the enterprise-provided data and at least a sub-set of the external data and storing correlation data in the VPDL in response to at least one association; and
reading, by a data exploration tool, at least a portion of the enterprise-provided data, at least a portion of the external data, and at least a portion of the correlation data, the data exploration tool being configured to generate one or more of visualizations and analytics by processing the at least a portion of the enterprise-provided data, the at least a portion of the external data, and the at least a portion of the correlation data.

9. The non-transitory computer-readable storage medium of claim 8, wherein providing a VPDL within a data exploration system at least partially comprises defining a namespace within the enterprise data lake, the namespace being specific to a user, for which the VPDL is provided.

10. The non-transitory computer-readable storage medium of claim 8, wherein storing enterprise-provided data in the VPDL at least partially comprises replicating enterprise data to the VPDL and projecting data lake data to the VPDL.

11. The non-transitory computer-readable storage medium of claim 8, wherein storing enterprise-provided data in the VPDL further comprises storing replicated metadata and projection metadata in the VPDL, at least a portion of the replicated metadata and the projected metadata representing correlations between enterprise-provided data.

12. The non-transitory computer-readable storage medium of claim 8, wherein automatically identifying associations between at least a sub-set of the enterprise-provided data and at least a sub-set of the external data comprises transmitting a request to a machine learning (ML) system and receiving a response from the ML system, the response comprising the associations.

13. The non-transitory computer-readable storage medium of claim 12, wherein the request comprises data descriptions and data content of at least a portion of the external data and at least a portion of the enterprise-provided data, the data descriptions and the data content being processed by the ML system to identify the associations.

14. The non-transitory computer-readable storage medium of claim 8, wherein operations further comprise converting the external data from a first format to a second format for storage within the VPDL.

15. A system, comprising:
a computing device; and
a computer-readable storage device coupled to the computing device and having instructions stored thereon which, when executed by the computing device, cause the computing device to perform operations for provisioning virtual private data lakes (VPDLs) and correlating data from disparate data sources, the operations comprising:
providing a VPDL within a data exploration system;
storing enterprise-provided data in the VPDL, the enterprise-provided data comprising enterprise data from at least one enterprise system and data lake data from an enterprise data lake;
importing, from at least one external data source, external data into the data exploration system;
automatically identifying associations between at least a sub-set of the enterprise-provided data and at least a sub-set of the external data and storing correlation data in the VPDL in response to at least one association; and
reading, by a data exploration tool, at least a portion of the enterprise-provided data, at least a portion of the external data, and at least a portion of the correlation data, the data exploration tool being configured to generate one or more of visualizations and analytics by processing the at least a portion of the enterprise-provided data, the at least a portion of the external data, and the at least a portion of the correlation data.

16. The system of claim 15, wherein providing a VPDL within a data exploration system at least partially comprises defining a namespace within the enterprise data lake, the namespace being specific to a user, for which the VPDL is provided.

17. The system of claim 15, wherein storing enterprise-provided data in the VPDL at least partially comprises replicating enterprise data to the VPDL and projecting data lake data to the VPDL.

18. The system of claim 15, wherein storing enterprise-provided data in the VPDL further comprises storing replicated metadata and projection metadata in the VPDL, at least a portion of the replicated metadata and the projected metadata representing correlations between enterprise-provided data.

19. The system of claim 15, wherein automatically identifying associations between at least a sub-set of the enterprise-provided data and at least a sub-set of the external data comprises transmitting a request to a machine learning (ML) system and receiving a response from the ML system, the response comprising the associations.

20. The system of claim 19, wherein the request comprises data descriptions and data content of at least a portion of the external data and at least a portion of the enterprise-provided data, the data descriptions and the data content being processed by the ML system to identify the associations.
